(19) United States
(12) Patent Application Publication
(10) Pub. No.: US 2005/0259570 A1
(43) Pub. Date: Nov. 24, 2005

(54) Fault recovery method and program therefor

(75) Inventors: Michiaki Hayashi, Saitama (JP); Kenichi Ogaki, Saitama (JP); Hideaki Tanaka, Saitama (JP); Ryouichi Harada, Tokyo (JP); Tomoshige Funasaki, Tokyo (JP); Hiroyuki Tanuma, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: KDDI CORPORATION, Tokyo (JP); NEC CORPORATION, Tokyo (JP)

(21) Appl. No.: 11/129,386

(22) Filed: May 16, 2005

(30) Foreign Application Priority Data
May 19, 2004 (JP) 2004-149547

(51) Int. Cl. H04L 1/00

(52) U.S. Cl. 370/216

(57) ABSTRACT

When there occurs a fault in any path of the MPLS or GMPLS network, a node which has detected the fault sends a notify message which is fault event information. A node which performs fault recovery receives the notify message (S1) and counting of the waiting time is triggered by this reception (S2). During this waiting time, LSA of OSPF is collected. When the waiting time is terminated, the node which performs fault recovery calculates alternative path based on the notify message and the LSA of OSPF (S3) and carries out fault recovery by restoration (S4).

### BACKGROUND OF THE INVENTION

1. Field of the Invention

The present invention relates to a fault recovery method and a program therefor. Particularly, the present invention relates to a fault recovery method which allows stable fault recovery processing in restoration which is a highly-reliable fault recovery method of an LSP (Label Switched Path) in a MPLS (Multi Protocol Label Switching) or GMPLS (Generalized MPLS) network, and a program therefor.

2. Description of the Related Art

Known as a conventional network fault recovery system are a protection system and a restoration system. According to the protection system, a protection path is prepared in advance for a working path and when there occurs a fault in the working path, the protection path is used as LSP. In this system, since a protection path is reserved in advance as an alternative path and there is no need to set a new fault-free path by calculating again, rapid recovery from fault becomes possible. This system is suitable as a fault recovery system for a network which requires speed enhancement.

On the other hand, according to the restoration system, when there occurs a fault in a working path, recalculation is performed to set a fault-free path as an alternative path. This system is poor in speed enhancement as compared with the protection system. However, since there is no need to reserve a protection path in advance and it is possible to make effective use of the band of a link, this system is suitable as a fault recovery system for a network which does not necessarily requires speed enhancement.

The following Non-Patent Document 1 discloses that when there occurs a fault in a GMPLS network, information about the fault event is notified of to an initiator node of an LSP to promote fault recovery. This notification utilizes a notify message of RSVP (Resource reSerVation Protocol), which allows the fault event to be notified directly from a node in the fault zone to the initiator node which performs fault recovery. This is an advanced function of the conventional MPLS technologies.

The following Patent Document 1 discloses the speed enhancement technique such that in order to compensate for weakness of the fault notifying mechanism in the conventional MPLS technologies, label processing associated with fault notification is devised to omit FEC at each transit node and search at an LSP-ID.

[Patent Document 1] Japanese Patent Application Laid-Open No. 2003-060680

[Non-Patent Document 1] Internet Engineering Task Force (IETF), RFC 3473

However, the techniques disclosed in the above patent document 1 and non-patent document 1 are such that fault occurrence is effectively notified to a node which performs fault recovery however what is communicated to the node is only fault information associated with a link that was being used as the LSP.

When a network configuration, for example a WDM (Wavelength Division Multiplexing) network configuration, such that a plurality of links are accommodated in one transmission line such as a fiber, is taken into account, if there occurs a fault in a link that was being used as the LSP, links other than the link often become faulty at the same time. As the notify message in the techniques of the above patent document 1 and non-patent document 1 does not serve to notify a node which performs fault recovery of a fault associated with a link that was used as another LSP or a fault associated with an unused link.

If the original LSP before being recovered is a path established by minimum cost calculation, another faulty link accommodated in the same transmission link is more likely to be selected by minimum cost calculation as an alternative path. Thus, when the node which performs fault recovery calculates (again) a path for restoration, if the restoration processing is carried out before topology states are synchronized sufficiently, this may result in causing an error in LSP fault recovery.

### SUMMARY OF THE INVENTION

It is an object of the present invention to provide a fault recovery method and a program therefor which allow stable fault recovery processing while eliminating the possibility to select another link in a fault zone as an alternative path.

In order to accomplish the object, the first feature of this invention is that a fault recovery method for setting a new LSP by alternative path calculation for a fault which occurs in an MPLS or GMPLS network, wherein a node which performs fault recovery receives a fault event notification which indicates occurrence of a fault after a fault localization is performed, waits for a predetermined waiting time which is more than a time taken to receive state information notifications of links other than a link that was being used as an LSP, and performs alternative path calculation based on the fault event notification and the state information notifications.

Also, the second feature of this invention is that a program for performing fault recovery by when there occurs a fault in an MPLS or GMPLS network, performing alternative path calculation by a computer to set a new LSP, said program comprises the steps of receiving a fault event notification which indicates occurrence of a fault after a fault localization is performed, waiting for a predetermined waiting time which is more than a time taken to receive state information notifications of links other than a link that was being used as an LSP, and performing alternative path calculation based on the fault event notification and the state information notifications.

Then, the waiting time for assuring that calculation of an alternative path is performed after state information notifications of links other than a link that was being used as the LSP are received is allowed to be set depending on the size of a network.

According to the present invention, since the node performing fault recovery receives state information notifications of links other than a link that was being used as the LSP, in addition to the fault event notification which indicates fault occurrence, before performing alternative path calculation based on them, it is possible to enhance recovery rate when fault recovery is performed based on what is called dynamic restoration system.

In addition, since the waiting time is allowed to be set depending on the size of the network, the present invention can be applied to a network of every size, and if the network size is changed by the way, the present invention can be applied to the size-changed network.

### BRIEF DESCRIPTION OF THE DRAWINGS

FIG. 1 is a view illustrating a configuration of a network to which the present invention is applied;

FIG. 2 is a view for explaining relationship between node count of the network and LSA averaged flooding time; and

FIG. 3 is a flowchart for showing fault recovery processing in a node which carries out fault recovery.

### DETAILED DESCRIPTION OF THE PREFERRED EMBODIMENT

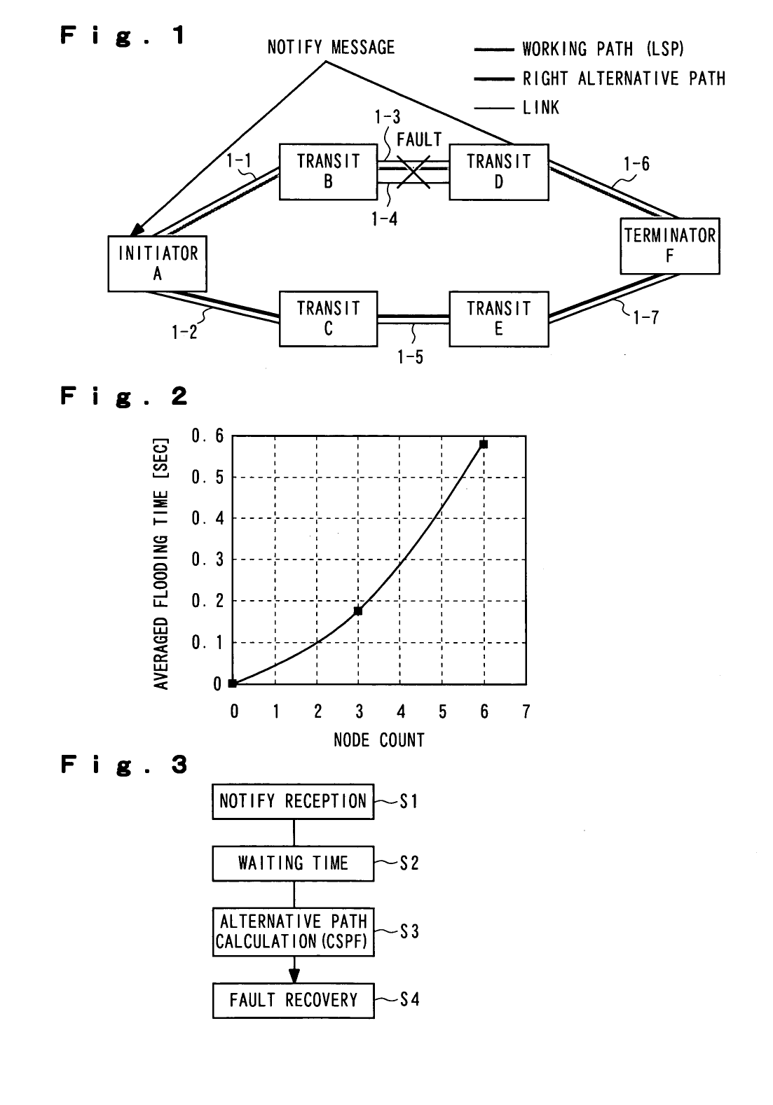

With reference to the drawings, embodiment of the present invention is described in detail below. FIG. 1 illustrates a configuration of a network to which the present invention is applied. This network is configured by connecting nodes A through F by lines of optical fibers or the like, in which network links 1-1, 1-2, 1-5, 1-6 and 1-7 are arranged between nodes A-B, nodes A-C, nodes C-E, nodes D-F and nodes E-F, respectively. Two network links 1-3 and 1-4 are arranged between nodes B-D. Here, it is assumed that node A is an initiator node (Initiator), node F is a terminator node (Terminator), and a working path (LSP) is established at a route through node A—transit node (Transit) B—transit node (Transit) D—node F.

If there occur faults on the link 1-3 between the transit nodes B and D and also on the link 1-4, simultaneously, the node in the fault zone (which is here, “transit node D”) performs fault localization and notifies the node which performs fault recovery (which is here, “initiator node A”) of a fault event by a notify message of RSVP.

By this notify message, the information of only the link 1-3 which was being used as the LSP is transmitted, but the information of fault occurrence on the unused link 1-4 in the same zone (between nodes B-D) is not transmitted. Accordingly, when the initiator node A receives the notify message and immediately starts calculation of alternative path for dynamic restoration processing, restoration to the right alternative path (in this example, path of node A—transit node C—transit node E—node F) is unlikely to be performed.

In other word, if the route of node A—transit node B—(link 1-3)—transit node D—node F is established as the LSP from minimum cost calculation, the route of node A—transit node B—(link 1-4)—transit node D—node F will be likely to be found from the minimum cost recalculation and selected as an alternative path. Such a situation can possibly happen particularly for large network.

Information about the fault of the unused link 1-4 hops over each node and is advertised to the whole network by LSA (Link state advertisement) of OSPF (Open Shortest Path First). This enables synchronization of a link state database of the whole network, however this synchronization requires averaged flooding time. This averaged flooding time depends on the network size and the number of links. Further, it is assumed that as compared with a notify message which can be directly notified from the node D in the fault zone to the initiator node A, an OSPF message which is notified hop by hop needs more time to be notified to the node A which performs fault recovery.

FIG. 2 shows relationship between the node count of the network and LSA averaged flooding time. As shown in FIG. 2, the LSA averaged flooding time varies largely depending on the node count of the network. In this example, the time required for LSA is around 200 msec for the network having three nodes and around 600 msec for the network having six nodes.

According to the present invention, in consideration of the fact that LSA averaged flooding time varies depending on the network as shown in this example, a waiting time for awaiting alternative path calculation until the LSA advertisement is completed is introduced to the node A which performs fault recovery. The node A which performs fault recovery can receive LSA within the waiting time to obtain state information about links other than the link was being used as the LSP.

Counting of the waiting time has only to be triggered by fault event notification of the notify message and a period of waiting time can be set long enough for the node A which performs fault recovery to obtain state information of links other than the link that was being used as the LSP, in consideration of the characteristics shown in FIG. 2 for example.

Since this waiting time is given, the node A which performs fault recovery does not only collect state information of the link 1-3 used by LSP by the notify message, but also collect by LSA of OSPF state information of the link 1-4 on which fault may occur. As a result, appropriate link state database is synchronized and right alternative path calculation can be achieved.

FIG. 3 shows a flowchart of the fault recovery processing in a node which performs fault recovery. When there occurs a fault in any path in the network, a node which has detected the fault performs fault localization and sends a notify message, which is fault event information, to the node which performs fault recovery.

When the node which performs fault recovery receives this notify message (S1), counting of the waiting time is triggered by reception of the message (S2). Since the node count of the network is six (nodes A through F) in the example on FIG. 1, the waiting time can be set at 600 msec according to the graph of FIG. 2.

During the waiting time, the node which performs fault recovery collects LSA of OSPF. After the waiting time is finished, the node which performs fault recovery carries out alternative path calculation based on the LSA of OSPF and the notify message (S3). This alternative path calculation is minimum cost calculation (CSPF: Constraint-base shortest path first) which takes into account constraints including link attribute if the network is GMPLS network, for example. At the moment when the alternative path calculation is carried out, the LSA of OSPF as well as the notify message is already acquired. Since the node which performs fault recovery carries out alternative path calculation based on these, it is possible to reduce the possibility to select a wrong alternative path at the time of restoration. Finally, the node which performs fault recovery carries out fault recovery processing in accordance with a result of alternative path calculation (S4).

The present invention can be implemented as a program for performing the aforementioned procedure of fault recovery processing to be executed by a computer mounted on a node which performs fault recovery. Such a program is stored in a storing medium such as a CD-ROM and read out to be installed thereby achieving a node in accordance with the present invention.

The embodiment of the present invention has been described up to this point. However, the present invention is not limited to the above-described embodiment and various modifications are possible. For example, the waiting time can be changed depending on the size of the network thereby allowing the present invention to be applied to a network of any size and even when the size of the network is changed. In the above-described embodiment, the node count is used to indicate the size of a network. Instead of the node count, the maximum number of hops when the LSA advertisement of OSPF is performed can be used. Or, what can be used to indicate the size of a network includes the distance between nodes, the band of control network, delay, the number of links and so on.

1. A fault recovery method for setting a new LSP by alternative path calculation for a fault which occurs in an MPLS or GMPLS network, wherein
a node which performs fault recovery receives a fault event notification which indicates occurrence of a fault after a fault localization is performed, waits for a predetermined waiting time which is more than a time taken to receive state information notifications of links other than a link that was being used as an LSP, and performs alternative path calculation based on the fault event notification and the state information notifications.

2. The fault recovery method as claimed in claim 1, wherein the waiting time is allowed to be set depending on a size of the network.

3. A program for performing fault recovery by when there occurs a fault in an MPLS or GMPLS network, performing alternative path calculation by a computer to set a new LSP, said program comprising the steps of:
receiving a fault event notification which indicates occurrence of a fault after a fault localization is performed;
waiting for a predetermined waiting time which is more than a time taken to receive state information notifications of links other than a link that was being used as an LSP; and
performing alternative path calculation based on the fault event notification and the state information notifications.

4. The program as claimed in claim 3, wherein the waiting time is allowed to be set depending on a size of the network.
